(19) United States
(12) Patent Application Publication
(10) Pub. No.: US 2023/0269485 A1
(43) Pub. Date: Aug. 24, 2023

(54) IMAGING DEVICE AND IMAGING METHOD

(71) Applicant: NIDEC COPAL CORPORATION, Tokyo (JP)

(72) Inventors: Yusuke AKAMATSU, Tokyo (JP); Yuusuke SUZUKI, Tokyo (JP)

(21) Appl. No.: 18/171,665

(22) Filed: Feb. 21, 2023

(30) Foreign Application Priority Data
Feb. 22, 2022 (JP) 2022-025855

(51) Int. Cl. H04N 23/72; H04N 23/76; H04N 23/74; H04N 23/71

(52) U.S. Cl. CPC H04N 23/72; H04N 23/76; H04N 23/74; H04N 23/71

(57) ABSTRACT

An imaging device includes an imaging element and a processor receiving subject light and generating data, a lens cover, an illuminometer, a light source emitting illumination light, an actuator switching the lens cover between a first state for restricting the subject light from entering the imaging element and a second state for allowing the subject light to enter, a switch including a first filter preventing the illumination light from entering the imaging element and a second filter allowing the illumination light to enter, to place the first filter or the second filter on a front surface of the imaging element based on a brightness level in a surrounding environment detected by the illuminometer, and a setter setting an amplification factor to be used by the processor in generating the data based on a brightness level in the surrounding environment detected by the illuminometer in the first state.

### RELATED APPLICATIONS

The present application claims priority to Japanese Application Number 2022-025855, filed Feb. 22, 2022, the disclosure of which is hereby incorporated by reference herein in its entirety.

### BACKGROUND

### Technical Field

The present invention relates to an imaging device and an imaging method.

### Description of the Background

Surveillance cameras are installed at various places such as nursing care facilities, hospitals, factories, and stores for crime and disaster prevention. Such surveillance cameras, which are imaging devices, are to be operated with privacy protection of individuals as subjects to be photographed. For privacy protection, a surveillance camera includes a light shield that covers a lens as appropriate.

Patent Literature 1 describes a camera that allows a light shield attached in front of a lens to be in an open or closed state in a manner recognizable from outside.

### CITATION LIST

### Patent Literature

Patent Literature 1: Japanese Unexamined Patent Application Publication No. 2014-56155

### BRIEF SUMMARY

However, the light shield switching from a closed state to an open state greatly changes light entering an imaging element, causing the imaging element to take more time to adjust sensitivity. This causes a delay before image data is generated with appropriate sensitivity after the light shield switches to the open state.

An imaging device according to an aspect of the present invention includes an imager that receives subject light through an opening in a housing and generates image data, a light shield between the opening and the imager to close the opening to restrict the subject light from entering the imager, a detector that detects a brightness level in a surrounding environment, an illumination light source that emits illumination light, a drive that switches the light shield between a first state in which the subject light is restricted from entering the imager and a second state in which the subject light is allowed to enter the imager, a switch including a first portion to prevent the illumination light from entering the imager and a second portion to allow the illumination light to enter the imager to place one of the first portion or the second portion on a front surface of the imager based on the brightness level in the surrounding environment detected by the detector, and a setter that sets an amplification factor to be used by the imager in generating the image data based on a brightness level in the surrounding environment detected by the detector in the first state.

An imaging method according to another aspect of the present invention includes receiving subject light through an opening in a housing with an imager and generating image data, detecting a brightness level in a surrounding environment, causing an illumination light source to emit illumination light, switching a light shield, located between the opening and the imager, between a first state in which the subject light is restricted from entering the imager and a second state in which the subject light is allowed to enter the imager, placing one of a first portion being a portion to prevent the illumination light from entering the imager or a second portion being a portion to allow the illumination light to enter the imager on a front surface of the imager based on the detected brightness level in the surrounding environment, and setting an amplification factor to be used in generating the image data based on a brightness level in the surrounding environment detected in the first state.

The technique according to the above aspects of the present invention shortens the time taken to generate image data with an appropriate amplification factor after the light shield switches to an open state.

### BRIEF DESCRIPTION OF DRAWINGS

FIG. 1 is an external view of an imaging device according to an embodiment in an open state.

FIG. 2 is an external view of the imaging device in a closed state.

FIG. 3 is an internal plan view of the imaging device.

FIG. 4 is a block diagram of a control system in the imaging device.

FIG. 5 is a flowchart of a process performed by the imaging device.

FIG. 6 is a flowchart of the process performed by the imaging device.

FIG. 7 is a flowchart of a process performed by an imaging device according to a modification.

FIG. 8 is a flowchart of the process performed by the imaging device according to the modification.

### DETAILED DESCRIPTION

One or more embodiments of the present invention will now be described in detail with reference to the drawings.

An imaging device according to the present embodiment may be used for any purpose and may be installed, for example, at a hospital, a nursing care facility, a factory, and a store as a surveillance camera or a monitoring camera. The imaging device is switchable between an imaging state and an imaging-disabled state. More specifically, the imaging device can switch between a closed state in which light cannot enter an imaging optical system and an open state in which light can enter the imaging optical system. Once the imaging device switches to the imaging-disabled state (closed state), a person being imaged can recognize that the imaging device has been switched to the imaging-disabled state. The imaging device is switchable between a normal imaging mode and a low-light imaging mode based on the brightness level in the external environment surrounding the imaging device. The imaging in the normal imaging mode is performed using light incident on the imaging optical system when the external environment is bright. The imaging in the low-light imaging mode is performed using illumination light emitted when the external environment is dark to allow imaging of a subject using the illumination light.

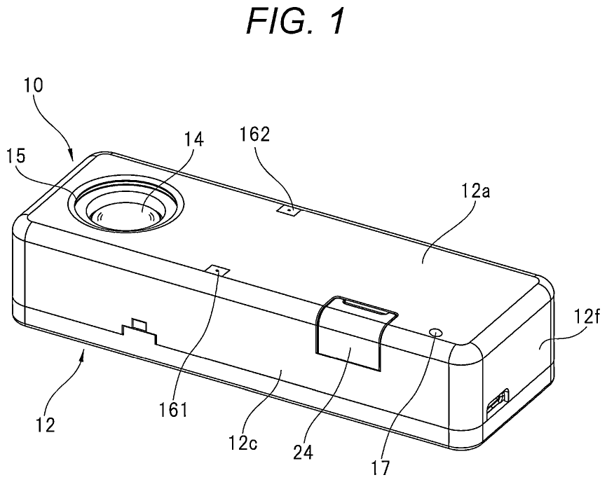

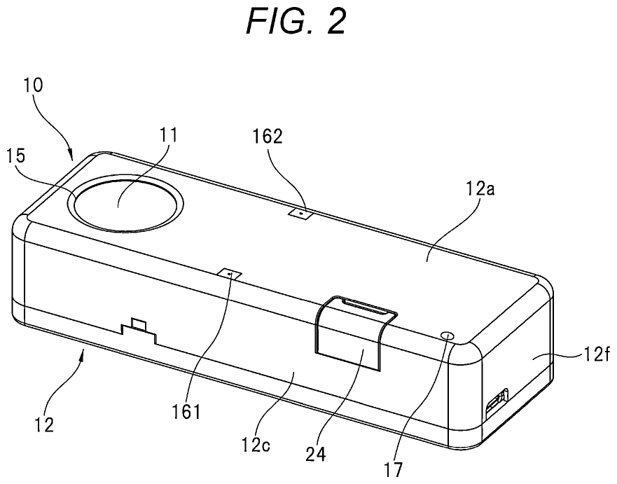

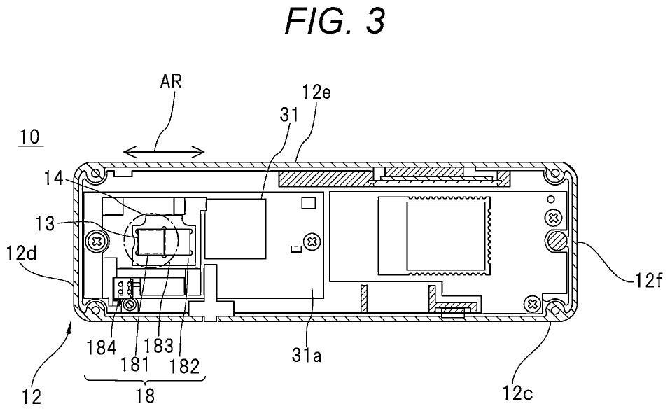

FIGS. 1 and 2 are external views of an imaging device 10. FIG. 1 is an external view of the imaging device 10 in the open state. FIG. 2 is an external view of the imaging device 10 in the closed state. FIG. 3 is an internal plan view of the imaging device 10.

As shown in FIGS. 1 to 3, the imaging device 10 includes a substantially rectangular housing 12. The housing 12 has a front surface 12a and side surfaces 12c, 12d, 12e, and 12f that meet the sides of the front surface 12a. Hereafter, the front surface 12a of the housing 12 is referred to as being upward, the surface of the housing 12 opposite to the front surface 12a being downward, the side surface 12c being frontward, the side surface 12d being leftward, and the side surface 12f being rightward.

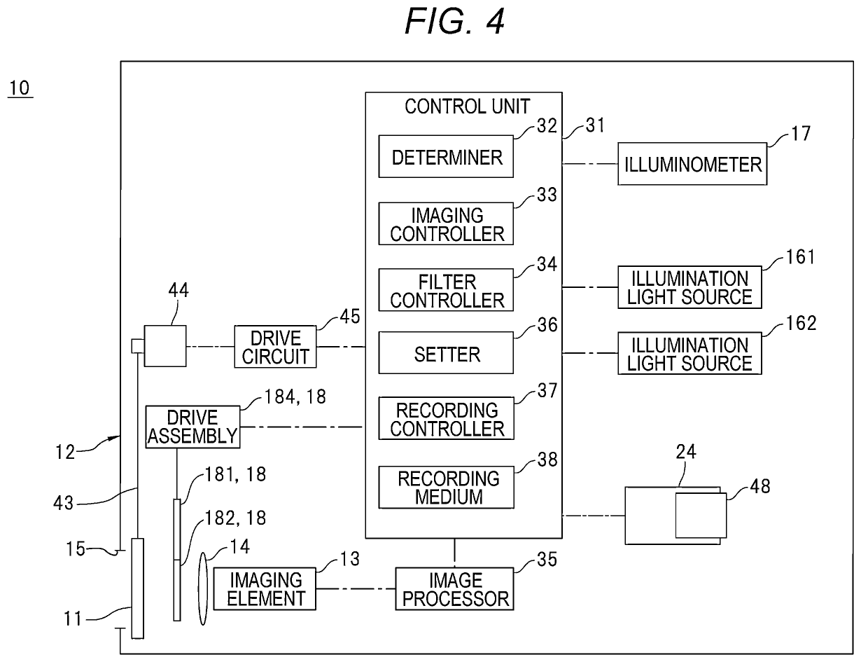

The housing 12 has, in or on the front surface 12a, a card slot 24 to receive a memory card 48 (refer to FIG. 4) and an opening 15, and illumination light sources 161 and 162 and an illuminometer 17.

The illumination light sources 161 and 162 are, for example, light-emitting diodes (LEDs) that emit light with wavelengths in the infrared region (infrared rays or infrared light). In the low-light imaging mode (described later), the imaging device 10 emits infrared light from the illumination light sources 161 and 162 as illumination light to illuminate a subject.

The illuminometer 17, which may be a photoresistor or a photodiode, is a detector that receives light from the surrounding environment (external environment) of the imaging device 10 and outputs a signal (luminance signal).

As shown in FIG. 3, the housing 12 in the imaging device 10 accommodates a lens cover 11, an imaging element 13 that is an image sensor such as a complementary metal-oxide semiconductor (CMOS) or a charge-coupled device (CCD), a lens 14 (imaging optical system) that focuses light from a subject (subject light) onto the imaging surface of the imaging element 13, a switch 18, and a control unit 31. The lens cover 11, the imaging element 13, the lens 14, and the switch 18 are arranged parallel to the front surface 12a.

The opening 15 in the front surface 12a of the housing 12 is on the optical axis of the lens 14. Subject light passing through the opening 15 enters the imaging element 13 through the lens 14 (imaging optical system). The imaging element 13 receives subject light through the opening 15 in the housing 12 and outputs an image signal resulting from photoelectric conversion. An image processor 35 (refer to FIG. 4), which is an image signal processor (ISP), described later processes the output image signal through various processes to generate image data. More specifically, the imaging element 13 and the image processor 35 function as an imager that receives subject light entering through the opening 15 in the front surface 12a of the housing 12 and generates image data.

The lens cover 11 is located along the optical axis of the lens 14 between the lens 14 and the opening 15 to open or close the opening 15. The lens cover 11 is movable either to an open position at which the opening 15 is open or to a closed position at which the opening is closed. The lens cover 11 moves on a plane orthogonal to the optical axis of the lens 14 (in other words, a plane parallel to the front surface 12a). When the lens cover 11 moves to the open position, the lens cover 11 is away from the optical axis of the lens 14 to uncover the opening 15 on the optical axis of the lens 14 as shown in FIG. 1 (open state). This causes the lens 14 to be exposed through the opening 15 in the housing 12 to allow subject light to enter the imaging element 13 through the lens 14.

When the lens cover 11 moves to the closed position, the lens cover 11 closes the opening 15 in the housing 12 as shown in FIG. 2 (closed state). This causes the lens cover 11 to cover the lens 14 to protect the lens 14 in the housing 12. At the closed position shown in FIG. 2, the lens cover 11 functions as a light shield that closes the opening 15 to restrict subject light from entering the imaging element 13. The lens cover 11 is also referred to as a lens barrier or a shutter.

The switch 18 switches between the state in which no illumination light from the illumination light sources 161 and 162 is allowed to enter the imaging element 13 and the state in which illumination light is allowed to enter the imaging element 13 based on the brightness level (luminance) in the external environment of the imaging device 10. More specifically, the switch 18 includes a first filter 181, a second filter 182, a holder 183, and a drive assembly 184. The first filter 181 is an infrared ray cut filter. The first filter 181 functions as a first portion that does not allow infrared light to enter the imaging element 13. The second filter 182 is, for example, a dummy lens, and functions as a second portion that allows infrared light to enter the imaging element 13.

The holder 183 holds the first filter 181 and the second filter 182 within a plane parallel to the front surface 12a. The holder 183 holds the first filter 181 on the left and the second filter 182 on the right in the direction indicated by arrow AR shown in FIG. 3. The holder 183 is movable in the direction indicated by arrow AR (in other words, the direction in which the first filter 181 and the second filter 182 are held). As the holder 183 moves along arrow AR, either the first filter 181 or the second filter 182 is placed on the optical axis of the lens 14 (in other words, the front surface of the imaging element 13).

The drive assembly 184 includes, for example, a drive, such as a stepping motor or a gear coupler, and a guide such as a lead screw. The drive assembly 184 is thus connected to the holder 183. When the drive assembly 184 is driven in response to a control signal from the control unit 31 (described later), the holder 183 connected to the drive assembly 184 moves along the plane parallel to the front surface 12a in the direction indicated by arrow AR.

A substrate 31a is a base for holding the imaging element 13 and the control unit 31. The substrate 31a is installed in a lower portion of the housing 12.

The control unit 31 includes a central processing unit (CPU), a memory, and other components. The control unit 31 is a processor that may read and execute a control program prerecorded in a recording medium 38 (refer to FIG. 4), such as a flash memory, to control various components of the imaging device 10. The control unit 31 controls the components in the normal imaging mode or the low-light imaging mode in an imaging process to operate the components. The normal imaging mode is used when the external environment of the imaging device 10 is bright. The low-light imaging mode is used when the external environment of the imaging device 10 is dark and lacks a sufficient amount of light. In the low-light imaging mode, the imaging device 10 applies infrared light as illumination light and captures an image of the subject illuminated with the infrared light.

The processing performed by the control unit 31 will be described in detail later.

### Control System for Imaging Device 10

FIG. 4 is a block diagram of the control system in the imaging device 10. As shown in FIG. 4, the control unit 31 in the imaging device 10 includes a determiner 32, an imaging controller 33, a filter controller 34, a setter 36, a recording controller 37, and the recording medium 38.

The determiner 32 performs a determination process to determine whether the external environment surrounding the imaging device 10 is bright or dark based on a luminance signal output from the illuminometer 17.

The imaging controller 33 controls driving of the imaging element 13 to cause the imaging element 13 to generate an image signal. The imaging controller 33 then performs the imaging process that causes the image processor 35 to generate image data based on the image signal. In imaging in the low-light imaging mode (described later), the imaging controller 33 supplies power to the illumination light sources 161 and 162 to cause infrared light to be output as illumination light.

Based on a determination result from the determiner 32, the filter controller 34 controls movement of the holder 183 by driving the drive assembly 184 to place the first filter 181 or the second filter 182 on the optical axis of the lens 14. In this case, the filter controller 34 places the first filter 181 that is an infrared ray cut filter on the optical axis of the lens 14 in the normal imaging mode, and places the second filter 182 that is a dummy lens on the optical axis of the lens 14 in the low-light imaging mode.

The setter 36 performs a setting process to set an amplification factor to be used by the image processor 35 in switching to the low-light imaging mode (in other words, when the external environment surrounding the imaging device 10 is dark) when the lens cover 11 is at the closed position to cover the opening 15.

The recording controller 37 performs a recording process to record image data generated by the image processor 35 into the memory card 48.

A link assembly 43 connects the lens cover 11 that opens or closes the opening 15 to an actuator 44. The actuator 44 is connected to a drive circuit 45. The drive circuit 45 is connected to the control unit 31 to drive the actuator 44 in response to a control signal (drive signal) from the control unit 31. The actuator 44 with the above structure drives the lens cover 11 to serve as a drive for switching the lens cover 11 between the closed state (first state) in which subject light is restricted from entering the imaging element 13 and the open state (second state) in which subject light is allowed to enter the imaging element 13.

### Processing Performed by Control Unit 31

The imaging device 10 generates image data and records the data into the memory card 48 with an imaging method described below. The imaging method includes a standby process performed when an imaging condition is unsatisfied (in other words, in the closed state) and the imaging process performed when the imaging device 10 in the closed state enters the open state in response to the imaging condition being satisfied. The imaging condition includes a wireless tag, such as an integrated circuit (IC), approaching a predetermined range. In this case, the control unit 31 determines whether a person carrying a wireless tag has entered a predetermined imaging area based on the intensity of a signal received with a radio communication module (not shown) connected to the control unit 31. When the intensity of the received signal exceeds a predetermined threshold Xa, the control unit 31 determines that the person has entered the imaging area, or in other words, the imaging condition is satisfied.

The imaging condition may include, for example, receiving a recording signal transmitted from a mobile terminal such as a smartphone, receiving an infrared ray transmitted from a remote control, and detecting a voice with predetermined information with a microphone (not shown).

### Standby Process

When the imaging condition is unsatisfied, the lens cover 11 is at the closed position. In this state, the imaging device 10 performs the standby process. When the imaging condition is satisfied, the lens cover 11 is at the open position, and the imaging device 10 performs the imaging process.

The standby process includes the setting process, the determination process, and an imaging preparation process. In the setting process, the setter 36 in the control unit 31 sets an amplification factor to be used by the image processor 35 to amplify the image signal to generate image data. In the determination process, the determiner 32 in the control unit 31 calculates a luminance value based on a luminance signal output from the illuminometer 17, and determines that the external environment is bright in response to the value exceeding a predetermined threshold and determines that the external environment is dark in response to the value being less than or equal to the threshold. In the imaging preparation process, the imaging controller 33 or the filter controller 34 in the control unit 31 controls the components to allow imaging after the imaging condition is satisfied. The setting process, the determination process, and the imaging preparation process will be described below.

### Setting Process

The setter 36 calculates a luminance value based on a luminance signal output from the illuminometer 17 and sets an amplification factor for the image signal based on the calculated luminance value. Typically, when the imaging device 10 captures an image, a smaller amount of light enters the imaging element 13 with its external environment being dark (in the low-light imaging mode) than with its external environment being bright (in the normal imaging mode). The setter 36 thus sets a higher amplification factor for the image processor based on the calculated luminance value as the external environment is darker (in other words, the luminance value is lower).

More specifically, amplification factors are prepared based on luminance values (brightness levels in the external environment) and are recorded in the recording medium 38 in, for example, a tabular format. The table includes the luminance values in the external environment divided into predetermined ranges, for which different amplification factors are recorded. For example, an amplification factor a is associated with a luminance value in the external environment being in a first range A. An amplification factor b lower than the amplification factor a is associated with a luminance value in the external environment being in a second range B indicating being brighter than in the first range A. An amplification factor c lower than the amplification factor b is associated with a luminance value in the external environment being in a third range C indicating being brighter than the second range B. An amplification factor d lower than the amplification factor c is associated with a luminance value in the external environment being in a fourth range D indicating being brighter than the third range C. An amplification factor e lower than the amplification factor d is associated with a luminance value in the external environment being in a fifth range E indicating being brighter than the fourth range D.

The setter 36 determines a range including the calculated luminance value among the first range A to the fifth range E by referring to the above table. The setter 36 then sets the amplification factor associated with the range as an amplification factor to be set for the image processor 35. In other words, the setter 36 sets the value based on the calculated luminance value among values predetermined for brightness levels as the amplification factor.

The above table may include each value associated with the luminance value in the external environment as a correction value for the amplification factor instead of the amplification factor. In this case, for example, a luminance value calculated using the image signal output from the imaging element 13 with the lens cover 11 being at the closed position is 1 (in other words, a reference value), and the correction value for the amplification factor is set as the amount of correction to the reference value. The amount of correction may be the difference from the above reference value or the ratio to the reference value.

### Determination Process

The determiner 32 calculates a luminance value based on a luminance signal output from the illuminometer 17, and determines that the external environment is bright in response to the value exceeding the predetermined threshold and determines that the external environment is dark in response to the value being less than or equal to the threshold. The predetermined threshold is set based on the results of testing or simulations, and is prerecorded in the recording medium 38.

### Imaging Preparation Process

The imaging controller 33 controls the operation of each component in the imaging device 10 based on the determination result of the determination process. When the luminance value exceeds the threshold and the surrounding external environment is determined to be bright, the imaging controller 33 causes the imaging element 13 to output an image signal resulting from photoelectric conversion. The image processor 35 generates image data using the amplification factor set for the image signal in the setting process. Thus, the imaging element 13 receives power and continues to be driven when the lens cover 11 is at the closed position or in the first state. The generated image data is recorded into the memory card 48. However, the lens cover 11 is at the closed position as described above. Thus, the image data to be generated does not include a subject outside the imaging device 10.

When the luminance value is less than or equal to the threshold and the surrounding external environment is determined to be dark, the imaging controller 33 performs a process to allow imaging in the low-light imaging mode (described later). The filter controller 34 first controls the drive assembly 184 to move the first filter 181 off the optical axis of the lens 14 and place the second filter 182 on the optical axis of the lens 14. The lens cover 11 thus moves to the open position to allow infrared light to enter the imaging element 13. The imaging controller 33 then causes the illumination light sources 161 and 162 to emit infrared light as illumination light as described above. The imaging controller 33 causes the imaging element 13 to output an image signal resulting from photoelectric conversion. The image processor generates image data using the amplification factor set for the image signal in the setting process. The generated image data is recorded into the memory card 48. However, the lens cover 11 is at the closed position as described above. Thus, the image data to be generated does not include a subject outside the imaging device 10.

When the imaging condition is satisfied with the above standby process being performed, the imaging device 10 advances to the imaging process. The imaging process will now be described.

### Imaging Process

When the imaging condition is satisfied, the imaging device 10 moves the lens cover 11 from the closed position to the open position for capturing an image of the subject. More specifically, the control unit 31 causes the drive circuit 45 to drive the actuator 44 to move the lens cover 11 to the open position with the link assembly 43. The imaging element 13 receives subject light entering through the opening 15 and outputs an image signal to the image processor 35. With the second filter 182 on the optical axis of the lens 14 in the low-light imaging mode, the imaging element 13 receives illumination light emitted from the illumination light sources 161 and 162 and reflected from the subject, and outputs an image signal.

The image processor 35 subjects the image signal output from the imaging element 13 to known image processes, such as an analog-to-digital (AD) conversion process, a signal amplification process, and a white balance process, and generates image data. In this state, the image processor 35 amplifies the image signal with the amplification factor set in the setting process during the above standby process. The recording controller 37 records the generated image data into the memory card 48.

The control unit 31 may record the time when the lens cover 11 moves to the open position. The recording controller 37 may delete, based on the time, image data recorded during the imaging preparation process from the image data recorded in the memory card 48.

Hereafter, the imaging controller 33 sets an amplification factor both in the normal imaging mode and in the low-light imaging mode based on image data to be generated. The image processor 35 generates image data using the set amplification factor. In other words, the amplification factor for the image signal is controlled with auto gain control (AGC). In this case, the imaging controller 33 performs one of first control or second control, or switches between the first control and the second control as appropriate to set the amplification factor. For the first control, the imaging controller 33 sets the amplification factor using correction data (correction table) generated by calculating amplification factors based on image data generated with the imaging device 10 being in the open state at a test site. The correction data includes multiple amplification factors calculated using image data generated with different brightness levels in the external environment at a test site and associated with the luminance of the image data. The correction data is recorded in the recording medium 38. The imaging controller 33 reads, from the correction data, an amplification factor associated with the luminance of the image data generated by the imaging process and sets the factor as the amplification factor to be used. For the second control, the imaging controller 33 stores amplification factors calculated based on image data generated with the imaging device 10 being in the open state at an installation site and sets an amplification factor to be used. When performing the first control or the second control, the imaging controller 33 may set the amplification factor to be used using results obtained from, for example, artificial intelligence (AI) learning amplification factors calculated based on image data and stored.

When the imaging condition is no longer satisfied, the control unit 31 causes the drive circuit 45 to drive the actuator 44 to move the lens cover 11 to the closed position with the link assembly 43. The filter controller 34 controls the drive assembly 184 to place the first filter 181 on the optical axis of the lens 14. The imaging controller 33 causes the illumination light sources 161 and 162 to stop emitting illumination light. However, the control unit 31 causes the illuminometer 17 to continue its operation without stopping the operation. Thus, the illuminometer 17 operates when the lens cover 11 is at the closed position and the imaging device 10 is in the closed state, allowing the setter 36 in the control unit 31 to perform the setting process. When the imaging device 10 is in the closed state, the control unit 31 may supply power to the illuminometer 17 at predetermined intervals with, for example, pulse control (pulse-width modulation control, or PWM control).

The above standby process is performed to allow an amplification factor appropriate for imaging in the low-light imaging mode to be set in a shorter time than when the amplification factor is controlled and set with AGC after the imaging condition is satisfied. This reduces the delay before the imaging is started in the low-light imaging mode after the imaging condition is satisfied.

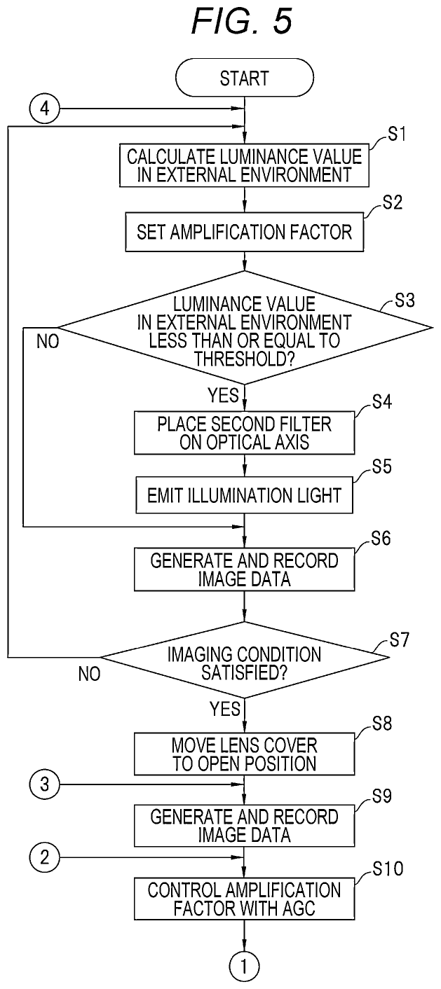

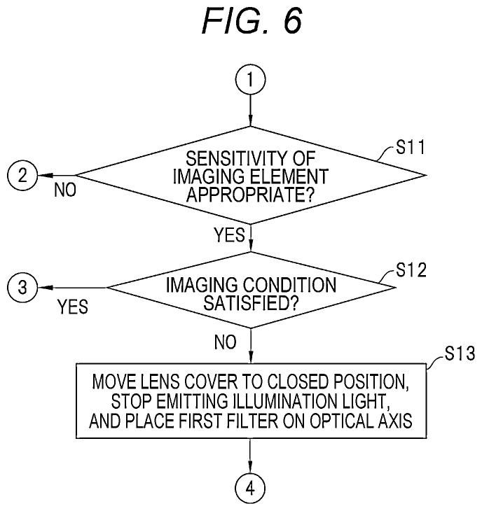

The process performed by the control unit 31 will be described with reference to the flowcharts in FIGS. 5 and 6. The control unit 31 reads and executes a program recorded in the recording medium 38 to perform the processing in the flowchart.

In step S1, the setter 36 in the control unit 31 calculates a luminance value in the external environment based on a luminance signal output from the illuminometer 17. The processing then advances to step S2. In step S2, the setter 36 reads the amplification factor recorded in the above table based on the calculated luminance value and sets the value as the amplification factor to be used by the image processor 35 in generating image data. The processing then advances to step S3. Steps S1 and S2 above correspond to the setting process.

In step S3, the determiner 32 in the control unit 31 determines whether the luminance value obtained in step S1 exceeds the predetermined threshold (determination process). When the calculated luminance value is less than or equal to the threshold (in other words, the external environment is dark), the determiner 32 yields an affirmative determination result. The processing then advances to step S4. When the luminance value exceeds the threshold (in other words, the external environment is bright), the determiner 32 yields a negative determination result. The processing then advances to step S6 (described later).

In step S4, the filter controller 34 in the control unit 31 controls the drive assembly 184 to move the first filter 181 off the optical axis of the lens 14 and place the second filter 182 on the optical axis of the lens 14. The processing then advances to step S5. In step S5, the imaging controller 33 in the control unit 31 causes the illumination light sources 161 and 162 to emit infrared light as illumination light as described above. The processing then advances to step S6.

In step S6, the imaging controller 33 causes the imaging element 13 to output an image signal, and causes the image processor 35 to generate image data based on the output image signal. The recording controller 37 records the image data generated by the image processor 35 into the memory card 48. The processing then advances to step S7. Steps S4 to S6 above correspond to the imaging preparation process.

In step S7, the control unit 31 determines whether the imaging condition is satisfied. When the intensity of the signal received with the radio communication module exceeds the threshold Xa as described above, the control unit 31 yields an affirmative determination result. The processing then advances to step S8. When the intensity of the received signal is less than or equal to the threshold Xa, the control unit 31 yields a negative determination result. The processing then returns to step S1.

In step S8, the control unit 31 causes the drive circuit 45 to drive the actuator 44 to move the lens cover 11 to the open position with the link assembly 43. The processing then advances to step S9. In step S9, the imaging controller 33 causes the imaging element 13 to output an image signal, and causes the image processor 35 to generate image data based on the output image signal. The recording controller 37 records the image data generated by the image processor 35 into the memory card 48. The processing then advances to step S10.

In step S10, the imaging controller 33 controls, with AGC, and calculates a new amplification factor based on the image data generated by the image processor 35. The imaging controller 33 then sets the calculated new amplification factor to be used by the image processor 35 in generating image data. The processing then advances to step S11 in FIG. 6.

In step S11 in FIG. 6, the determination is performed as to whether the sensitivity of the imaging element 13 is appropriate. When the sensitivity of the imaging element 13 is appropriate, the control unit 31 yields an affirmative determination result. The processing then advances to step S12. When the sensitivity of the imaging element 13 is inappropriate, the control unit 31 yields a negative determination result. The processing then returns to step S10 in FIG. 5.

Steps S9 to S11 above correspond to the imaging process.

In step S12, the determination is performed as to whether the imaging condition is satisfied. When the intensity of the signal received with the radio communication module remains exceeding the threshold Xa, the control unit 31 yields an affirmative determination result. The processing then returns to step S9 in FIG. 5. When the intensity of the received signal is less than or equal to the threshold Xa, the control unit 31 yields a negative determination result. The processing then advances to step S13. In step S13, the control unit 31 causes the drive circuit 45 to drive the actuator 44 to move the lens cover 11 to the closed position with the link assembly 43. When the imaging process is performed in the low-light imaging mode, the imaging controller 33 stops emitting illumination light from the illumination light sources 161 and 162, and the filter controller 34 controls the drive assembly 184 to move the holder 183 and place the first filter 181 on the optical axis of the lens 14. The processing then returns to step S1 in FIG. 5. In other words, the processing in steps S1 and S2 (operation of the illuminometer 17) during the standby process is continued.

The structure according to the above embodiment produces the advantageous effects described below.

(1) The setter 36 in the control unit 31 sets an amplification factor to be used by the image processor 35 in generating image data based on the brightness level in the surrounding environment detected by the illuminometer 17 in the first state (closed state) in which the lens cover 11 restricts subject light from entering the imaging element 13. This allows setting of an amplification factor appropriate for imaging to be performed after the imaging condition is satisfied with the lens cover 11 being at the closed position. This structure reduces the delay before image data is generated with an appropriate amplification factor after the lens cover 11 moves to the open position, as compared with when the amplification factor is controlled and set with AGC. The illuminometer 17 included in the imaging device 10 continues its operation with the lens cover 11 being at the closed position to allow the setter 36 to set the amplification factor to be used in generating image data based on the brightness level in the external environment with the lens cover 11 being at the closed position.

(2) The setter 36 sets a value predetermined for each brightness level in the surrounding environment as the amplification factor. The amplification factor to be used is set to the amplification factor recorded in, for example, a tabular format, and can be set in a shorter time than when the amplification factor is calculated every time based on output from the illuminometer 17.

(3) The switch 18 places the second filter 182 on the front surface of the imaging element 13 when the brightness level in the surrounding environment of the imaging device 10 detected by the illuminometer 17 is less than or equal to the threshold in the first state (closed state) in which the lens cover 11 restricts subject light from entering the imaging element 13. This structure reduces the delay before image data is generated with an appropriate amplification factor in the low-light imaging mode after the lens cover 11 moves to the open position, as compared with when the second filter 182 for transmitting infrared light as illumination light is placed on the front surface of the imaging element 13 and then imaging is started.

(4) The illumination light sources 161 and 162 emit illumination light when the brightness level in the surrounding environment of the imaging device 10 detected by the illuminometer 17 is less than or equal to the threshold in the first state (closed state) in which the lens cover 11 restricts subject light from entering the imaging element 13. This structure reduces the delay before image data is generated with an appropriate amplification factor in the low-light imaging mode after the lens cover 11 moves to the open position, as compared with when illumination light is emitted and then imaging is started.

(5) After the lens cover 11 moves to the open position, the imaging controller 33 sets the amplification factor based on the image data generated by the image processor 35 in the second state (open state). The amplification factor set during the standby process can be adjusted based on an amplification factor calculated based on subject light actually entering the imaging element 13, thus improving the image quality of image data to be generated.

Although various embodiments and modifications are described above, the present invention is not limited to the embodiments and the modifications. Other forms implementable within the scope of technical idea of the present invention fall within the scope of the present invention.

Although the imaging device 10 generates image data in the closed state in the above embodiment, the imaging device 10 may start generating image data after the imaging condition is satisfied. In other words, the imaging element 13 may not receive power and may stop driving until the imaging condition to start generating image data is satisfied.

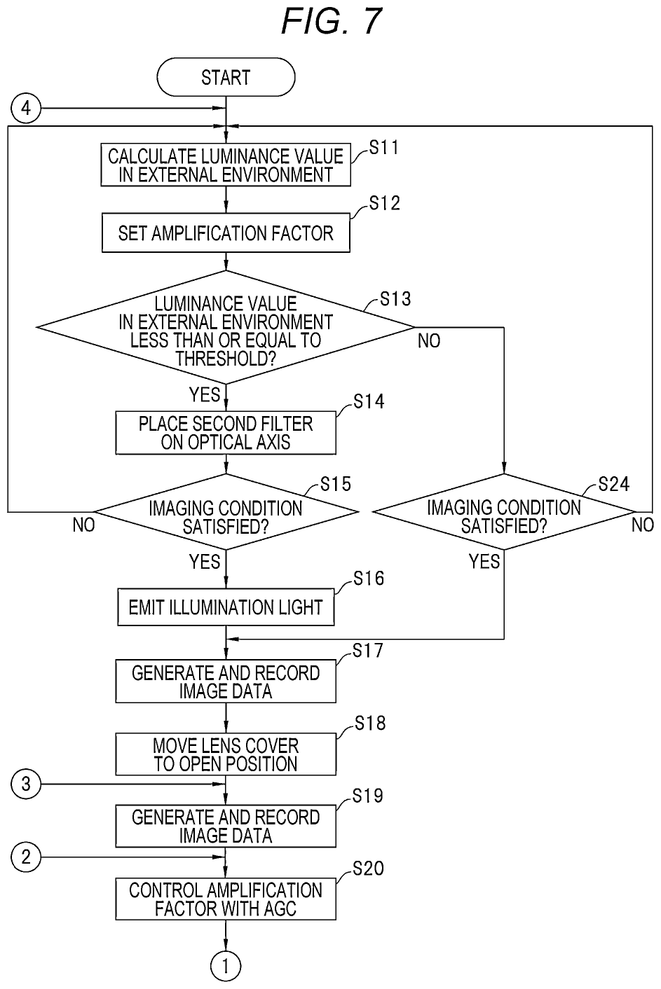

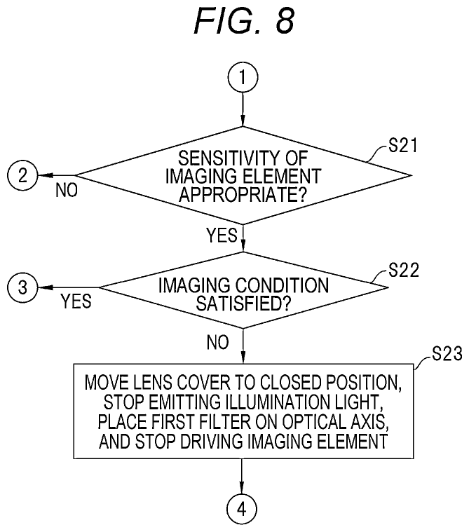

FIGS. 7 and 8 are flowcharts in this case. The processing in steps S11 to S14 is the same as the processing in steps S1 (calculation of a luminance value in the external environment) to S4 (placement of the second filter on the optical axis) in FIG. 5. When the result of determination is negative in step S13, the processing advances to step S24 (described later).

In step S15 subsequent to step S14, the control unit 31 determines whether the imaging condition is satisfied as in step S7 in FIG. 5. When the imaging condition is satisfied, the control unit 31 yields an affirmative determination result. The processing then advances to step S16. When the imaging condition is unsatisfied, the control unit 31 yields a negative determination result. The processing then returns to step S11.

In step S24 after the negative determination result in step S13 as well, the determination is performed as to whether the imaging condition is satisfied as in step S7 in FIG. 5. When the imaging condition is satisfied, the processing advances to step S17. When the imaging condition is unsatisfied, the processing returns to step S11.

In step S16, the illumination light sources 161 and 162 emit illumination light as in step S5 in FIG. 5. In subsequent step S17, the imaging controller 33 causes the imaging element 13 to start driving. As in step S6 in FIG. 5, the imaging controller 33 causes the imaging element 13 to output an image signal, and causes the image processor 35 to generate image data based on the output image signal. The recording controller 37 records the image data generated by the image processor 35 into the memory card 48. The subsequent processing in each of steps S18 to S22 in FIG. 8 is the same as the corresponding processing in step S8 in FIG. 5 (movement of the lens cover 11 to the open position) to step S12 in FIG. 6 (determination as to whether the imaging condition is satisfied). In step S23 after the negative determination result in step S22, the control unit 31 performs the same processing as in step S13 in FIG. 6. The imaging controller 33 causes the imaging element 13 to stop driving. The processing then returns to step S11 in FIG. 7.

This reduces the power consumption of the imaging device 10 until the imaging condition is satisfied.

The imaging device 10 may switch the processing to be performed between the above processing in FIGS. 7 and 8 and the above processing in FIGS. 5 and 6 in response to, for example, a setting operation performed by a user.

What is claimed is:

1. An imaging device, comprising:
an imager configured to receive subject light through an opening in a housing and generate image data;
a light shield between the opening and the imager, the light shield being configured to close the opening to restrict the subject light from entering the imager;
a detector configured to detect a brightness level in a surrounding environment;
an illumination light source configured to emit illumination light;
a drive configured to switch the light shield between a first state in which the subject light is restricted from entering the imager and a second state in which the subject light is allowed to enter the imager;
a switch including a first portion to prevent the illumination light from entering the imager and a second portion to allow the illumination light to enter the imager, the switch being configured to place one of the first portion or the second portion on a front surface of the imager based on the brightness level in the surrounding environment detected by the detector; and
a setter configured to set an amplification factor to be used by the imager in generating the image data based on a brightness level in the surrounding environment detected by the detector in the first state.

2. The imaging device according to claim 1, wherein
the setter sets a value based on the brightness level in the surrounding environment detected by the detector among values predetermined for brightness levels as the amplification factor.

3. The imaging device according to claim 1, wherein
when the brightness level detected by the detector with the light shield being in the first state is less than or equal to a threshold, the switch places the second portion on the front surface of the imager with the light shield being in the first state.

4. The imaging device according to claim 3, wherein
when the brightness level detected by the detector with the light shield being in the first state is less than or equal to the threshold, the illumination light source emits the illumination light with the light shield being in the first state.

5. The imaging device according to claim 1, further comprising:
an imaging controller configured to set, after the light shield switches from the first state to the second state, the amplification factor based on image data generated by the imager in the second state.

6. The imaging device according to claim 5, wherein
the imaging controller performs one of first control or second control to set the amplification factor, or switches between the first control and the second control to set the amplification factor, the first control is performed based on an amplification factor determined based on image data generated in the second state at a test site, and the second control is performed based on an amplification factor determined based on image data generated in the second state at an installation site.

7. The imaging device according to claim 6, wherein
when performing the first control or the second control, the imaging controller sets the amplification factor using a result obtained from learning the amplification factor determined based on the image data.

8. The imaging device according to claim 1, wherein
the imager generates the image data in the first state.

9. The imaging device according to claim 1, wherein
the imager stops driving until a condition to start generating the image data is satisfied in the first state.

10. An imaging method, comprising:
receiving subject light through an opening in a housing with an imager and generating image data;
causing a detector to detect a brightness level in a surrounding environment;
causing an illumination light source to emit illumination light;
switching a light shield between a first state in which the subject light is restricted from entering the imager and a second state in which the subject light is allowed to enter the imager, the light shield being between the opening and the imager;
placing one of a first portion or a second portion on a front surface of the imager based on the detected brightness level in the surrounding environment, the first portion being a portion to prevent the illumination light from entering the imager, the second portion being a portion to allow the illumination light to enter the imager; and
setting an amplification factor to be used in generating the image data based on a brightness level in the surrounding environment detected in the first state.
